(19) United States
(12) Patent Application Publication
(10) Pub. No.: US 2006/0061010 A1
(43) Pub. Date: Mar. 23, 2006

(54) Process for manufacturing hybrid components as well as components manufactured according to this process

(76) Inventor: Hans-Georg Huonker, Villingen-Schwenningen (DE)

Correspondence Address: McGLEW AND TUTTLE, P.C., SCARBOROUGH STATION, SCARBOROUGH, NY, 10510-9227, US

(21) Appl. No.: 11/225,833

(22) Filed: Sep. 13, 2005

(30) Foreign Application Priority Data
Sep. 13, 2004 (DE) DE 10 2004 044 61

(51) Int. Cl. B29C 45/14

(52) U.S. Cl. 264/272.11

(57) ABSTRACT

A process for manufacturing a hybrid component. To manufacture a hybrid component with electronic components in a possibly continuous manufacturing process, it is proposed according to the present invention that the electronic component be extrusion-coated with a hot melt adhesive melting at low temperature and to extrusion coat the intermediate product formed with a conventional plastic suitable for injection molding in an additional injection molding operation. On the one hand, damage to the electronic component is reliably prevented from occurring by this procedure, and, on the other hand, a hybrid component can be manufactured with a housing that is insensitive to external effects.

### CROSS REFERENCE TO RELATED APPLICATIONS

This application claims the benefit of priority under 35 U.S.C. § 119 of German Application DE 10 2004 044 614.8 filed Sep. 13, 2004, the entire contents of which are incorporated herein by reference.

### FIELD OF THE INVENTION

The present invention pertains to a process for manufacturing a hybrid component such as a metal and plastic component.

### BACKGROUND OF THE INVENTION

Hybrid components are components formed of different materials, especially metal and plastic. For example, pre-profiled, strip-shaped pressed screens, which are wound off from a coil by means of a winder, are used to manufacture such components. Via a feed means, the pressed screen enters a combined bending and cutting machine, which has corresponding bending and cutting tools in order to prepare a pre-pressed and pre-bent sheet metal part to be introduced into an injection mold cavity.

In other words, the strip-shaped pressed screen is a sheet metal strip, which contains pre-pressed sheet metal parts, which are later extrusion coated to form the finished hybrid component. The individual sheet metal parts are now integrated in the strip-shaped pressed screen one after another. Some bending operations are carried out on the component in the bending and cutting machine. The completely bent component is cut off from the strip-shaped pressed screen by pressing, so that the (sheet metal) component to be extrusion coated is now in the form of an individual part. This individual part is now transferred for the manufacture of hybrid components, for example, to a flexible manufacturing plant, by means of a corresponding material handling means.

This component, designed as a sheet metal component, may represent, fore example, the contact elements of a plug connection, a switch or the like in the finished hybrid component. This sheet metal component is now fed, for example, to a horizontal injection molding machine and inserted there on the nozzle side of the machine. After the injection mold is closed, the sheet metal part is extrusion coated with plastic. After extrusion coating and opening of the injection mold, the prefabricated hybrid component is removed on the ejection side of the horizontal injection molding machine. If the hybrid component is an electric connection plug, the individual plug type contacts connected to one another after the extrusion coating must be separated from one another in an additional operation. The hybrid component is fed for this purpose to a press, which is provided with a corresponding separating tool.

The connection points between the contacts are used to stabilize the contacts during the extrusion coating, so that the contacts will remain in their desired position after the injection molding operation. These connections must be severed after the extrusion coating in order for the plug type connection to be able to assume its intended function. Furthermore, provisions may be made for testing the hybrid component for flashover and for optically checking and electronically measuring the hybrid component in additional testing stations. If the hybrid component meets the preset criteria after passing through the operations, the hybrid component is placed in a last operation on transport pallets, which may be designed, for example, as so-called blister packs.

It was now found that the manufacture of hybrid components is extremely difficult when these are to additionally contain electronic components, which are likewise to be protected by a plastic against external effects. Such electronic components are needed, for example, in the form of sensors for controlling the engines in motor vehicles. However, since these electronic components are highly sensitive to external effects, e.g., high temperatures, moisture or even corrosive liquids, such as oil, brake fluid, etc., these electronic components must be protected by a corresponding housing.

To manufacture, for example, such a sensor, a so-called “premolding,” which has the connection contacts accessible from the outside as well as connection elements that are located on the inside in the later component, has hitherto been prepared at first according to the above-described process. These connection elements are electrically contacted with an electronic component, for example, with an electronic board, in a subsequent operation. The electronic component is now contacted electrically with the connection elements of the premolding in another operation by preparing corresponding soldered joints and is stationarily connected to the premolding, for example, by means of a lock-in connection. To protect the electronic components against external effects, especially moisture or the like, it is necessary to surround them with a protective housing. The protective housing is manufactured in advance in a separate injection molding operation and subsequently placed on the premolding. The sealing with the basic body of the premolding may be carried out, for example, by a bonded connection, welded connection or in another manner.

In the pre-assembled state, this housing surrounds at least part of the premolding together with the electronic component. Since this housing forms a cavity around the electronic component, it may be necessary to fill the housing in another operation in order to prevent, for example, water of condensation from forming. The housing has for this purpose, at least at one point, an opening, through which the still remaining cavity between the housing and the components of the premolding located therein and the electronic component is filled with, e.g., a synthetic resin, so that the electronic component, in particular, is protected against external weather effects by this casting compound. The additional housing is necessary in such hybrid components to “envelope” the electronic component, on the one hand, and it also remains at the “premolding” after the casting in order to also improve the mechanical properties against external mechanical effects.

After the manufacture of this intermediate product, it can be provided in another process step with the mounting housing, with which the finished hybrid component containing the sensor is mounted, for example on an internal combustion engine.

To manufacture the mounting housing, the intermediate product is introduced in another process step into another cavity of an injection molding machine, and the mounting housing is cast on from a conventional, injection-moldable plastic. The process described is thus extremely complicated and therefore expensive, but it has hitherto been necessary, because the electronic components cannot be extrusion coated with a conventional injection-moldable plastic. This is not possible because, for example, the temperatures are on the order of magnitude of 350° C. during injection molding and the electronic components as well as the soldered joints would be damaged at such high temperatures during the injection molding operation and the hybrid component would thus be unfit for use. In addition, conventional, injection-moldable plastics usually contain abrasive elements, so that, for example, the strip conductors on the surface of a board to be extrusion coated can also be damaged during the extrusion coating.

### SUMMARY OF THE INVENTION

Thus, the object of the present invention is to manufacture a hybrid component with electronic components in a possibly continuous manufacturing process.

A hybrid component with electronic components can be manufactured in the process according to the present invention in an extremely simple manner and in a continuous manufacturing process. In particular, conventional injection molding machines can be used for this.

Such an injection molding machine may have a multicomponent mold for carrying out the individual consecutive injection molding operations.

According to the invention, a premolding is prepared first. This premolding comprises or consists essentially of at least a metal component and an electronic component electrically in contact with the metal component. This premolding is extrusion coated in the next process step with a hot melt adhesive having a low melting point in an injection mold to manufacture an intermediate product, casting on a heat-insulating buffer zone at least in the area of the electronic component. The intermediate product formed is extrusion coated with a conventional, injection-moldable plastic in another process step. The hot melt adhesive is partially melted by the plastic during the injection molding operation in the area of the buffer zone and forms with this a mixed zone consisting of plastic and hot melt adhesive.

In case of hybrid components of a simpler shape, the plastic cast on in the last process step may already form the finished housing, because the duration of the injection molding operation is extremely short in case of housings of a simple shape and “melting out” of the hot melt adhesive cannot therefore occur.

If the duration of the extrusion coating of the intermediate product with a conventional plastic is longer, the buffer zone may be formed with a correspondingly great wall thickness and the sprue can be placed, for example, in this area. If this is not sufficient or melting out of the hot melt adhesive cannot be ruled out even if this measure is taken, provisions may also be made according to the present invention for casting on only a kind of enveloping body with a small wall thickness from the conventional plastic during the extrusion coating of the intermediate product. Short duration of the extrusion coating operation is achieved due to this measure, so that the hot melt adhesive is prevented from melting out with certainty. After the enveloping body has been cast on, the final housing can be cast on in another process step. The hot melt adhesive is protected by the enveloping body both thermally and mechanically.

It is common to all processes that the individual process steps can be carried out in a continuous manufacturing process. In particular, the consecutive injection molding operations can be carried out, for example, in a conventional injection molding machine with a multicomponent mold, so that fully automatic manufacture of a hybrid component can be carried out.

Depending on the design of the hybrid component to be manufactured, provisions may also be made for manufacturing at first a metal component, which is to be extrusion coated, by cutting and bending to manufacture a premolding. This is then introduced into a cavity of an injection mold, the metal component being provided with outer connection elements and inner connection elements, wherein the outer connection elements are arranged outside the cavity of the injection mold and the inner connection elements are arranged within the cavity of the injection mold. The metal component is now extrusion coated with a conventional, injection-moldable plastic, leaving free the inner connection elements, to manufacture a first premolding.

This first premolding is then equipped with an electronic component and this is electrically contacted with the inner connection elements. The first premolding is subsequently extrusion coated, together with the electronic component, in a second, larger cavity with a hot melt adhesive to form an intermediate product forming a second premolding. After this injection molding operation, the intermediate product is extrusion coated at least in the area of the hot melt adhesive that is accessible from the outside with a conventional injection-moldable plastic, which forms an enveloping body protecting the hot melt adhesive.

In this process for manufacturing at first a metal component, which is to be extrusion coated, by cutting and bending to manufacture a premolding, the first premolding differs from the process in which the premolding is prepared first in that a kind of protective or receiving body is cast first on its metal component in a first injection molding operation with a conventional, injection-moldable plastic for the electronic component. Such a support body may be necessary in case of larger and more complicated electronic components in order to support this component via the support body cast on before in the cavity of an injection mold during the extrusion coating with the hot melt adhesive.

It shall be mentioned here once again that such hot melt adhesives are generally known and have been used for a rather long time now for extrusion coating electronic components. The drawback of these injection-moldable hot melt adhesives is that the mechanical properties thereof frequently fail to meet the requirements during the later use of the hybrid component. As was already mentioned above, the manufacturers also impose diverse mechanical, thermal and even chemical requirements on such hybrid components, such as dimensional stability, wear resistance, insensitivity to corrosive liquids as well as surface hardness, requirements which are not met by such injection-moldable hot melt adhesives, especially if such hybrid components are used with electronic components in motor vehicles.

These injection-moldable hot melt adhesives are characterized in that they have, in particular, an especially low melting point, so that the electronic components cannot be damaged during extrusion coating. In addition, these hot melt adhesives contain no abrasive substances, by which the surfaces of the electronic components could be damaged during the extrusion coating of the electronic components. The pressure is also extremely low during the injection molding operation in case of such injection-moldable hot melt adhesives, so that destruction of the electronic component due to pressure cannot occur, either.

This component, comprising the premolding with the electronic component as well as the component extrusion coated with the hot melt adhesive, is additionally extrusion coated now according to the present invention with a conventional, injection moldable plastic. A hybrid component can be manufactured by this procedure in a continuous injection molding process, in which the component is only manufactured in different, consecutive injection molding operations between the individual process steps. This is extremely inexpensive, on the one hand, and, on the other hand, an injection molding is made available, which has the required mechanical properties and at the same time also the necessary tightness, especially in the area of the electronic component.

Due to a corresponding embodiment of the premolding, to which the electronic component is attached, complete extrusion coating of the electronic component is also guaranteed, without any inclusions of air being able to be formed, as this happens during the conventional filling with a casting compound.

The “hot melt adhesive” is slightly “melted” on its surface during the subsequent extrusion coating, especially in the area of the “hot melt adhesive,” because of the higher pressure and the higher melting point of the plastic to be extrusion coated, so that a plastic mixture of the outer plastic and the hot melt adhesive is formed. To protect the electronic component against unacceptable thermal effects, provisions may be made for the mixed zone to have a distance of at least 0.5 mm from the electronic component. Additional tightness of the entire component is thus achieved as well.

Complicated filling or attachment of additional housings can be eliminated according to this process according to the present invention.

Based on the drawings, the process for a hybrid component will be explained in greater detail below on the basis of an exemplary embodiment of a hybrid component. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a vertical sectional view of a “premolding,” in which the necessary metal contact elements have already been inserted and extrusion coated;

FIG. 2 is a perspective view of the premolding from FIG. 1 together with an electronic component;

FIG. 3 is a perspective view showing the premolding from FIGS. 1 and 2 with the electronic component attached;

FIG. 4 is a vertical sectional view of the premolding with the electronic component in a cavity for extrusion coating with hot melt adhesive;

FIG. 5 is the cavity from FIG. 4 after the conclusion of the injection molding operation;

FIG. 6 is a perspective view of the intermediate product manufactured according to FIGS. 4 and 5;

FIG. 7 is a perspective view showing the intermediate product from FIG. 6 in another injection molding cavity for partial extrusion coating with a conventional plastic;

FIG. 8 is the view from FIG. 7 after the extrusion coating operation;

FIG. 9 is the perspective view of the finished hybrid component;

FIG. 10 is a sectional view through an injection mold with a premolding comprising a metal component as well an electronic component;

FIG. 11 is a perspective view of an intermediate product comprising the components shown in FIG. 10, which are extrusion coated with a hot melt adhesive;

FIG. 12 is a perspective view of the intermediate product from FIG. 11 with partially extrusion-coated conventional plastic; and

FIG. 13 is by phantom lines the component from FIG. 12 with a finished plastic housing cast on.

### DESCRIPTION OF THE PREFERRED EMBODIMENTS

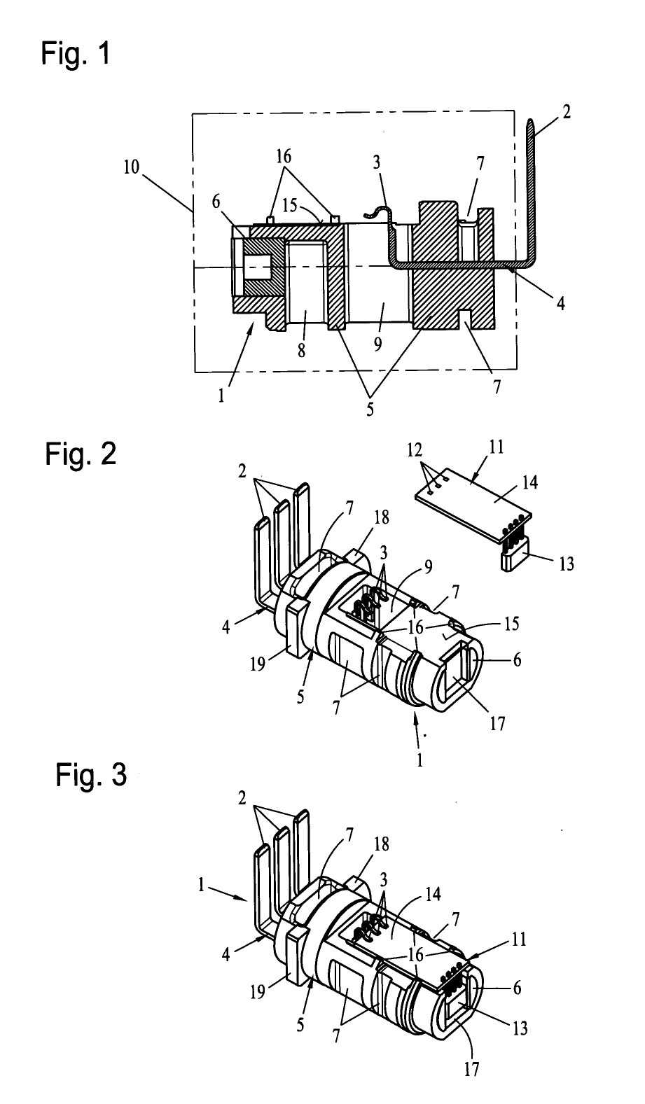

Referring to the drawings in particular, FIG. 1 shows a vertical section through a premolding 1, which is designed as a connection plug in this exemplary embodiment. The premolding 1 has a metal component 4 with a plurality of outer connection contacts 2 for this (FIG. 2), which are provided with inner connection elements 3 designed as terminal lugs. This premolding 1 is manufactured in an injection molding operation, in which the metal component 4 was partially extrusion coated with a plastic body 5. This plastic body 5 forms a basic body, in which, for example, a metal cooling element 6 is also embedded by molding in this exemplary embodiment on the left-hand side for cooling an electronic component.

Furthermore, it can be recognized from FIG. 1 that this basic body 5 has a plurality of depressions 7, 8 and recesses 9, so that an extremely small amount of plastic material is used to manufacture this basic body 5 by the injection molding operation. FIG. 1 also shows by phantom lines the corresponding injection mold 10, as it is known from the state of the art.

This premolding 1 shown in FIG. 1 is the result of the first process step according to the present invention for manufacturing a hybrid component.

FIG. 2 shows a perspective view of this finished premolding 1 together with an electronic component 11. In this exemplary embodiment, this electronic component 11 has three contact fields 12 on the top side, which can be brought into electric contact with the three terminal lugs 3 of the metal component 4 in the mounted state. For example, this electronic component 11 is provided at its right-hand end with a transistor 13, which is already contacted with the board 14 of this electronic component 11.

To mount the electronic component 11, the premolding 1 has, on the top side, a flat support surface 15, to which the electronic component 11 with its board 14 can be attached. Four locking elements 16, with which the board 14 can be caused to be lockingly engaged when placed on the support surface 15, are provided in this exemplary embodiment in the edge area of this support surface 15. The board 14 with its contact springs 12 is brought under the three contact lugs 3, so that an electric contact will automatically become established here. These contact lugs 3 can subsequently also be additionally soldered to the contact fields 12.

When the electronic component 11 is attached, the transistor 13 enters a recess 17 of the cooling element 6, as this is shown in FIG. 3. Furthermore, it can be recognized from FIGS. 2 and 3 that in its left-hand area, the premolding 1 has radially projecting mounting webs 18 and 19, via which the later hybrid component can be caused to lockingly engage a corresponding “opposite plug.”

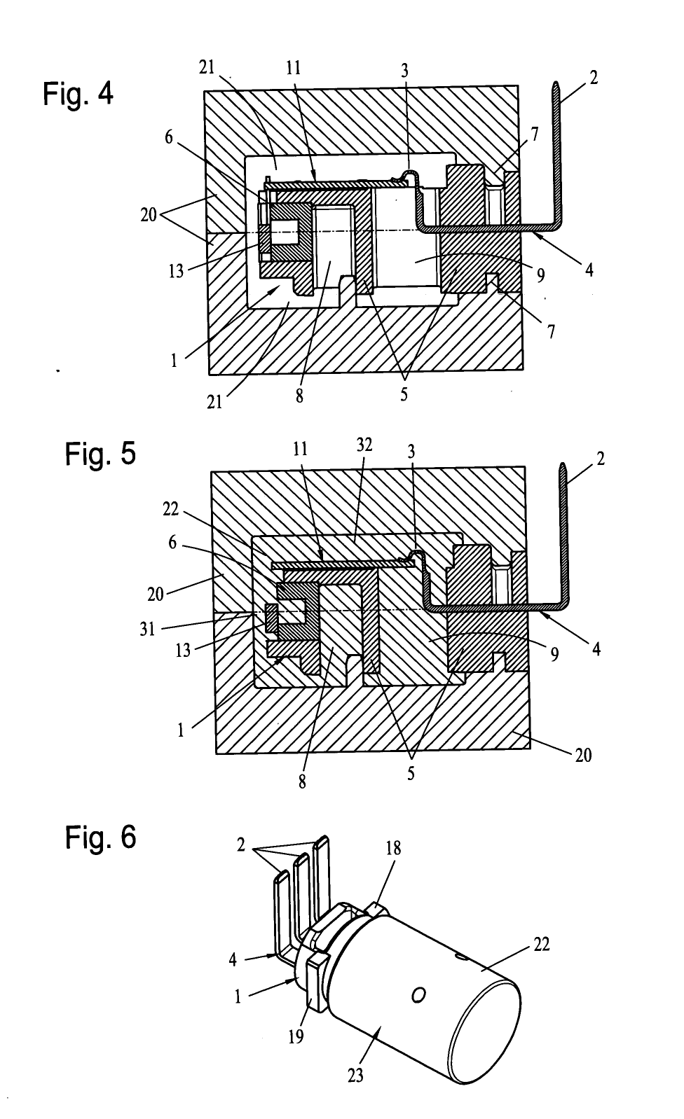

As is shown in FIG. 4, the premolding 1 thus provided with the electronic component 11 is introduced into another injection mold 20. It can be recognized that the cavity 21 formed surrounds the premolding, especially in the area of the electronic component 11, and also has a greater radial distance, especially from the electronic component 11 as well as from the transistor 13.

Because of the continuous recess 9 provided, the electronic component 11 is not completely extrusion coated with an injectable hot melt adhesive together with the transistor 13 during the subsequent injection molding operation. This can be seen, for example, in FIG. 5. An injectable hot melt adhesive, which is injected into the cavity 21 with a low temperature of about 200° C. and with extremely low pressure, is used here to extrusion coat the electronic component.

The intermediate product 23 obtained as a result is shown in a perspective view in FIG. 6. It can be recognized that only the connection contacts 2 project from the plastic areas of the premolding 1 as well as of the cylindrical body 22, which is cast on in a cylindrical form and consists of a hot melt adhesive.

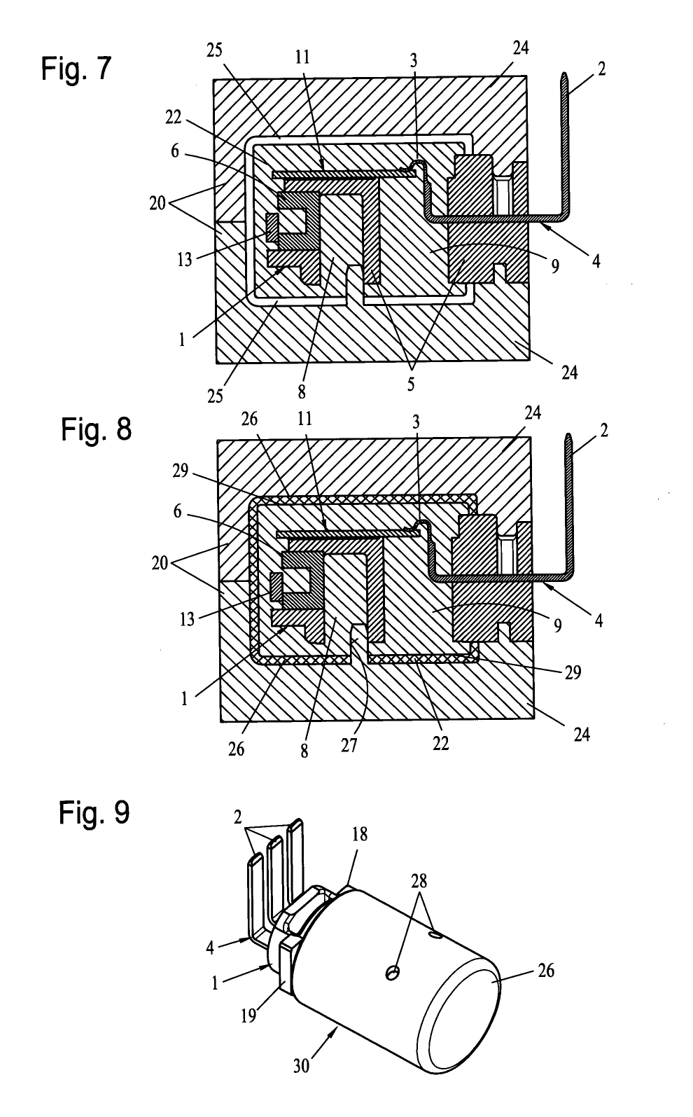

As is apparent from FIGS. 7 and 8, this intermediate product 23 is introduced according to the present invention into another injection mold 24, which forms a surrounding cavity 25 around the intermediate product 23 in the area of the cylindrical body 22. After the additional injection molding operation, in which a conventional plastic with high melting point is used, an enveloping body 26, which possesses extremely favorable mechanical properties, is formed around the cylindrical body 22, as this is apparent from FIG. 8. One or more depressions 27 and 28 may be provided now in this enveloping body 26, also together with the subjacent cylindrical body 22 prepared by injecting hot melt adhesive, and the finished hybrid component 30 can be fixed via these depressions, as this is shown in FIG. 9 in a perspective view, during installation, e.g., in a motor vehicle. It is important in this connection that these depressions 27 and 28 also be formed from the enveloping body 26, which also brings about the necessary properties of the hybrid component 30 in terms of high mechanical strength.

A mixed zone 29, in which a kind of fusion of the enveloping body 26 and the cylindrical body 22 takes place in the contact area of these bodies, is formed during the extrusion coating of the cylindrical body 22 consisting of hot melt adhesive because of the higher temperature and the higher pressure. By selecting the injection pressure correspondingly and ensuring correspondingly good ventilation of the cavity 25, extremely short injection times can be reached, so that the low-melting hot melt adhesive 22 is not destroyed during its extrusion coating and, in particular, the mixed zone 29 will not reach the electronic component 11.

To rule out with certainty that the mixed zone and the thermal effects associated therewith could destroy the electronic component 11, provisions are made here for the hot melt adhesive to surround the electronic component 11 at least with a “wall thickness” of a few mm. The wall thickness of the enveloping body 28 can also be selected to be extremely small, so that more rapid cooling can also take place here after the last injection molding operation, and the electronic component cannot be thermally overloaded.

It can be recognized that a hybrid component 30 with extremely favorable mechanical properties can be manufactured by means of the process according to the present invention described here by a plurality of consecutive injection molding operations. There is no need for a separate component to be pushed over the premolding, and a subsequent filling is not necessary for the protection of the electronic component 11.

Due to the design of the premolding 1, complete extrusion coating of the electronic component 11 with hot melt adhesive is ensured, and the wall thicknesses, which surround the electronic component 11 as well as the basic body of the premolding at least in some areas, are selected to be such that no unacceptable thermal load can act, especially on the electronic component 11 and the transistor 13, even during the subsequent extrusion coating of this intermediate product 23 according to FIGS. 7 and 8.

Absolute tightness is achieved even between the enveloping body 26 and the cylindrical body 22 consisting of hot melt adhesive due to the formation of a mixed zone, which consists of a mixture of the hot melt adhesive and the conventional injecting molding plastic, so that the hybrid component 30 is absolutely tight and also protected against external mechanical effects after this extrusion coating. Conventional injection-moldable plastics are defined here, for example, as partially crystalline thermoplastics or any other high-melting, injection-moldable plastic, which melts in temperature ranges above 300° C. and is used for the injection molding of, for example, plastic housings.

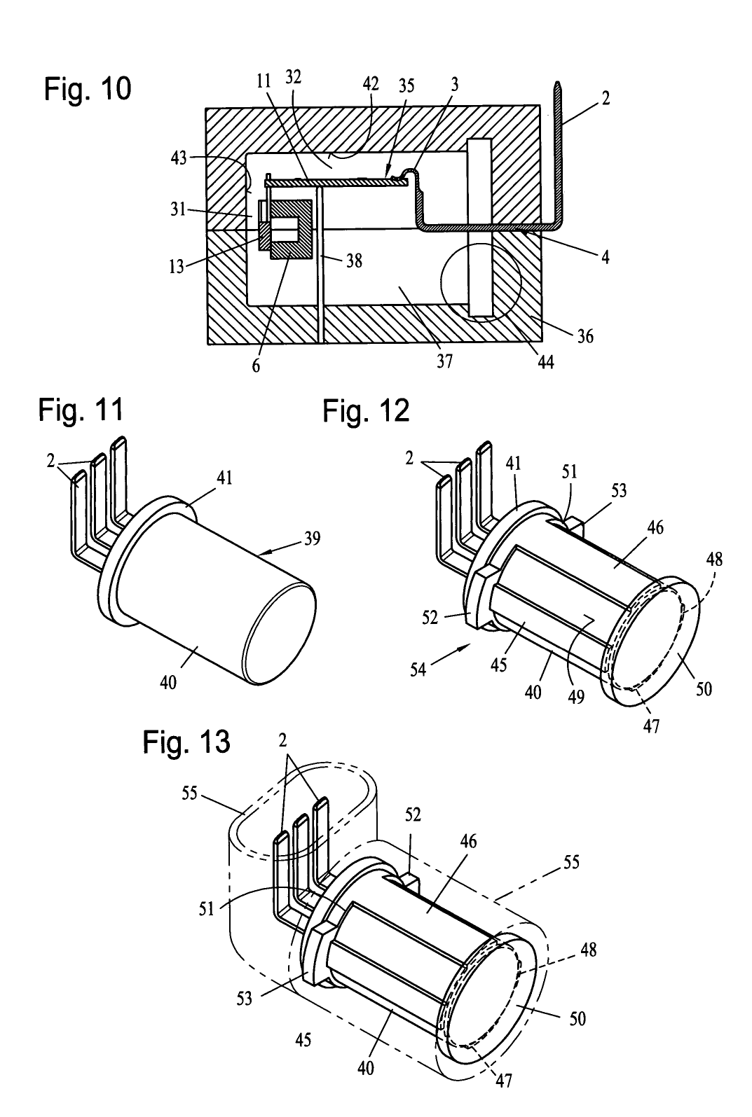

The process for manufacturing a hybrid component, in which the premolding 35 comprises only the metal component 4, the electronic component 11 as well as the transistor 13 with its cooling element 6, will be described on the basis of FIGS. 10 through 13. As can be recognized from FIG. 10, this premolding 35 is introduced into an injection mold 36, the outer connection contacts 2 of the metal component 4 projecting from the injection mold 36 and the cavity 37 thereof. The electronic component 11 is electrically connected to the metal component 4 via the connection elements 3 designed as terminal lugs and is supported within the cavity 37 of the injection mold 36 by a plunger 38, so that it will remain in its preset position during the subsequent injection molding operation.

The intermediate product 39 shown in FIG. 11, in which the premolding 35 from FIG. 10 is completely extrusion coated with hot melt adhesive, is formed during the extrusion coating of the premolding 35 after the injection molding operation. This hot melt adhesive forms a cylindrical body 40, in the end area of which, which is located in the area of the outwardly projecting connection contacts 2, a radially outwardly projecting support web 41 is cast on. It can be recognized from FIG. 10 that the electronic component 11, in particular, has a relatively short distance from the upper limiting wall 42 of the cavity 37 in the upper area of the cavity 37.

The transistor 13, which is used as a Hall sensor here, also has a relatively short distance from the left side wall 43 of the cavity 37. This means that the wall thickness consisting of hot melt adhesive, which surrounds the electronic component 11 and the transistor 13, is relatively small after the injection molding operation. This wall thickness should not be smaller than 0.5 mm and preferably 2 mm, so that a sufficiently large buffer zone will be formed between the surface of the cylindrical body 40 and the surfaces of the premolding 35 during the subsequent extrusion coating of this cylindrical body 40 from FIG. 11, which was manufactured according to the injection molding operation.

These buffer zones prevent with certainty the hot melt adhesive from melting especially in the area of the electronic component 11 or in the area of the transistor 13 up to this component and especially thermal destruction of these components from occurring as a result during the subsequent extrusion coating of the cylindrical body 40.

If it is not possible to maintain such a minimum distance for reasons related to the design of the cylindrical body 40, provisions may, furthermore, be made according to the present invention for the sprue to be located during the extrusion coating of the cylindrical body 40, for example, in a zone 44 (FIG. 10), in which the buffer zone is considerably larger. It is ensured by the measure that when the conventional plastic “flows around” the cylindrical body 40, precisely these zones in the area of the electronic component 11 and the transistor will be extrusion coated last, so that the thermal effect is extremely weak over time in these areas and melting of the hot melt adhesive up to the electronic component 11 and up to the transistor 13 is prevented from occurring with certainty and, in particular, thermal heating up to these components is prevented from occurring with certainty.

FIG. 12 shows a perspective view of the component extrusion coated with conventional plastic in some areas and the cylindrical body 40 of the component. It can be recognized that a total of four longitudinal webs 45, 46, 47 and 48 were cast on in this case in the area of the outer jacket surface 49 of the cylindrical body 40. Furthermore, a base plate 50 was cast on in the right-hand end area and a ring-shaped body 51 was cast on the cylindrical body 40 in the left-hand end area of the cylindrical body 40. Two diametrically opposed holding tongues 52 and 53 are cast on this ring-shaped body 51 as a one-piece component of the ring-shaped body 51, the holding tongues being provided for the further extrusion coating of the cylindrical body 40 and for introducing and holding the latter in another cavity for the final extrusion coating of the cylindrical body 40.

It can be recognized that the longitudinal web 46 is arranged in the area of the electronic component 11 from FIG. 10 which is located inside. The base plate 50 is located, by contrast, in the area of the transistor 13 from FIG. 10. Because of this “pre-extrusion coating” of the cylindrical body 40 consisting of hot melt adhesive, an extremely short injection time is obtained, so that the thermal effect on the hot melt adhesive can be kept extremely short, especially in the areas of the electronic component 11 and the transistor 13. It is thus ensured that the electronic component 11 as well as the transistor 13 cannot be damaged in any way.

After this extrusion coating of the cylindrical body 43 to form the intermediate product 54 from FIG. 12, the rest of the housing 55 can then be extrusion coated in an additional injection molding process, as this is indicated by phantom lines in FIG. 13. Provisions may be made in this connection for completely embedding the longitudinal webs 45 through 48 as well as the base plate 50, the ring-shaped body 51 and the two holding tongues 52 and 53 and for these components to form a homogeneous unit with the housing 55, likewise consisting of a conventional plastic, during this final injection operation for manufacturing the housing 55. Heat stress is thus prevented with certainty from occurring on the components located on the inside, such as the electronic component 11 as well as the transistor 13 from FIG. 10 due to the longitudinal webs 45 through 48 cast on in advance as well as the base plate 50.

Provisions may also be made for the housing 55 to be cast on with the base plate 50 and with the ring-shaped body with its two holding tongues 52 and 53 in an injection molding operation without the longitudinal webs 45, 46, 47 and 48 extrusion coated in advance. It should be borne in mind in this connection that the two buffer zones 31 and 32 shall have a correspondingly great wall thickness in order to prevent the hot melt adhesive from melting up to the electronic component 11 and the transistor 13 and an increased thermal effect on these components 11 and 13 with certainty.

On the other hand, and in addition to the wall thickness provided as a buffer zone, the sprue for extrusion coating the cylindrical body 40 may also be placed in an area of the corresponding injection mold, which area is located at a greater distance from the electronic component 11 and the transistor 13, as this is shown in FIG. 10 with the reference number 44. It is achieved as a result that the cylindrical body 40 is extrusion coated with a conventional plastic only at the end of the extrusion coating operation, so that the duration of the thermal effect on the cylindrical body 40 is kept extremely short in these areas and an unacceptably strong thermal effect is prevented from occurring in these areas with certainty.

Thus, it can be recognized that a hybrid component can be manufactured by the process according to the present invention in consecutive injection molding processes, for example, in an injection molding machine with a multicomponent mold, without an additional effort, in an extremely favorable manner.

While specific embodiments of the invention have been shown and described in detail to illustrate the application of the principles of the invention, it will be understood that the invention may be embodied otherwise without departing from such principles.

What is claimed is:

1. A process for manufacturing a hybrid component, the process comprising the steps of:
manufacturing a premolding comprising at least a metal component manufactured by cutting and bending as well as an electronic component in electrical contact with said metal component;
extrusion coating said premolding in an injection mold with a hot melt adhesive having low melting point to manufacture an intermediate product, wherein a heat-insulating buffer zone is cast on at least in the area of said electronic component;
extrusion coating of said intermediate product with a conventional, injection-moldable plastic, wherein said plastic partially melts the hot melt adhesive during the injection molding operation especially in the area of said buffer zone and forms a mixed zone consisting of plastic and hot melt adhesive.

2. A process in accordance with claim 1, wherein
a mixed zone, in which the hot melt adhesive and the plastic are blended during extrusion coating, is provided between the extrusion coated hot melt adhesive that forms a cylindrical body and the plastic forming an enveloping body surrounding same; and
said mixed zone has a distance of at least 0.5 mm from said electronic component.

3. A process in accordance with claim 1, wherein one or more conventional injection molding machine is used for the extrusion coating in the individual process steps.

4. A process in accordance with claim 3, wherein the injection molding machine has a multicomponent mold for carrying out the process steps.

5. A process for manufacturing a hybrid component, the process comprising the steps of:
manufacturing a metal component to be extrusion coated by cutting and bending metal;
introducing the metal component into a cavity of an injection mold, wherein said metal component is arranged with external connection elements outside the cavity of said injection mold and with internal connection elements within the cavity of said injection mold;
extrusion coating said metal component with a conventional, injection-moldable plastic, leaving free said inner connection elements for preparing a premolding;
equipping said premolding with an electronic component as well as contacting said premolding with said inner connection elements;
introducing said premolding together with said electronic component into a second, larger cavity, said larger cavity surrounding at least an area surrounding said electronic component;
extrusion coating said premolding, at least in an area of said electronic component, with a hot melt adhesive to form an intermediate product;
introducing said intermediate product into a third, larger cavity; and
extrusion coating said intermediate product at least in an area of the hot melt adhesive, which is accessible from the outside, with a conventional injection-moldable plastic, which forms an enveloping body protecting said hot melt adhesive or said finished plastic housing of said hybrid component.

6. A process in accordance with claim 5, wherein
a mixed zone, in which the hot melt adhesive and the plastic are blended during extrusion coating, is provided between the extrusion coated hot melt adhesive that forms a cylindrical body and the plastic forming an enveloping body surrounding same; and
said mixed zone has a distance of at least 0.5 mm from said electronic component.

7. A process in accordance with claim 6, wherein one or more conventional injection molding machine is used for the extrusion coating in the individual process steps.

8. A process in accordance with claim 7, wherein the injection molding machine has a multicomponent mold for carrying out the process steps.

9. A process for manufacturing a hybrid plastic/metal component, the process comprising the steps of:
manufacturing a premolding comprising at least a metal component manufactured by cutting and bending as well as an electronic component in electrical contact with said metal component;
extrusion coating said premolding in an injection mold with a hot melt adhesive having low melting point to manufacture an intermediate product, wherein a heat-insulating buffer zone is cast on at least in the area of said electronic component;
extrusion coating of said intermediate product with a conventional, injection-moldable plastic, wherein said plastic partially melts the hot melt adhesive during the injection molding operation especially in the area of said buffer zone and forms a mixed zone consisting of plastic and hot melt adhesive.

10. A process for manufacturing a hybrid component according to claim 9, wherein said step of manufacturing a premolding comprises:
manufacturing a metal component to be extrusion coated by cutting and bending metal;
introducing the metal component into a cavity of an injection mold, wherein said metal component is arranged with external connection elements outside the cavity of said injection mold and with internal connection elements within the cavity of said injection mold;
extrusion coating said metal component with a conventional, injection-moldable plastic, leaving free said inner connection elements; and
equipping said premolding with an electronic component as well as contacting said premolding with said inner connection elements.
